(19) United States
(12) Patent Application Publication
(10) Pub. No.: US 2021/0335538 A1
(43) Pub. Date: Oct. 28, 2021

(54) THREE-DIMENSIONAL WOUND IRON CORE, METHOD AND DEVICE FOR MANUFACTURING THE SAME BY USING SINGLE-LAYER AMORPHOUS STRIP

(71) Applicant: QINGDAO YUNLU ADVANCED MATERIALS TECHNOLOGY CO., LTD., Qingdao, Shandong (CN)

(72) Inventors: Xiaoyu LI, Qingdao, Shandong (CN); Jing PANG, Qingdao, Shandong (CN); Qinghua LI, Qingdao, Shandong (CN); Fei CHENG, Qingdao, Shandong (CN); Chen LI, Qingdao, Shandong (CN)

(73) Assignee: QINGDAO YUNLU ADVANCED MATERIALS TECHNOLOGY CO., LTD., Qingdao, Shandong (CN)

(21) Appl. No.: 16/487,387

(22) PCT Filed: Dec. 12, 2018
(86) PCT No.: PCT/CN2018/120510

§ 371 Date: Aug. 20, 2019

(30) Foreign Application Priority Data
Aug. 3, 2018 (CN) 201810879193.0

(51) Int. Cl. H01F 41/02; H01F 27/25; H01F 27/30

(52) U.S. Cl. CPC H01F 41/0226; H01F 27/306; H01F 27/25

(57) ABSTRACT

A method for manufacturing a three-dimensional wound iron core by using a single-layer amorphous strip includes: step 1) of cutting, step 2) of positioning, including positioning a raw material at a positioning location by using a first location detecting apparatus, a control apparatus collecting information from the first location detecting apparatus and transmitting the information to the cutting apparatus, step 3) of tension detecting including a tension detecting apparatus detecting a tension of the raw material, the control apparatus collecting information from the tension detecting apparatus and transmitting the information to a winding apparatus, step 4) of trimming to obtain a winding strip, step 5) of winding location detecting including positioning the winding strip at a positioning location by using a second location detecting apparatus, the control apparatus collecting information from the second location detecting apparatus and transmitting the information to the winding apparatus, and step 6) of winding.

The present application claims priority to Chinese Patent Application No. 201810879193.0, titled “THREE-DIMENSIONAL WOUND IRON CORE, METHOD AND DEVICE FOR MANUFACTURING THE SAME BY USING SINGLE-LAYER AMORPHOUS STRIP”, filed on Aug. 3, 2018 with the Chinese Patent Office, which is incorporated herein by reference in its entirety.

### FIELD

The present disclosure relates to the technical field of manufacture of amorphous three-dimensional wound iron core transformers, and in particular to a three-dimensional wound iron core, a method and a device for manufacturing the three-dimensional wound iron core by using a single-layer amorphous strip.

### BACKGROUND

Amorphous three-dimensional wound iron core transformers have advantages of less material consumption, improved performance, reduced wastage, and reduced noise. In addition, a transformer made of an amorphous material has the advantage of reduced no-load loss. Therefore, amorphous three-dimensional wound iron core transformers are worth popularization. Manufacture of the iron core is a basis for manufacturing such transformers, and the process for manufacturing the iron core includes multiple processing steps that can be optimized. Single-layer amorphous strips, as the raw material of the iron core, are unrolled, laminated, and rolled to form a five-layer strip or a multi-layer strip, which is provided to customers. The processes of unrolling, laminating, and rolling increase the manufacture cost.

Currently, in China, an amorphous three-dimensional wound iron core is manufactured through the following processes. A roll of a multi-layer strip is released and cut, and is trimmed to form a trapezoid-shape strip. Then, the trapezoid-shape trip is collected and is wound to form a single iron core by using a winding device. The whole manufacturing process has a strict requirement on the deviations in the size of the trimmed strip and the size of the wound strip. Since strips of different layers of the five-layer strip have different widths and lengths, layers may be further unaligned during the process of cutting or winding, which adversely affects the processing accuracy, thereby hampering high-speed manufacturing and resulting in low manufacturing efficiency. Taking a five-layer strip with a length of 1000 m for example, a difference between lengths of an inner layer strip and an outer layer strip is 0.211 m, which increases the manufacturing difficulty during the process of cutting and winding. A conventional solution is to additionally provide a roll system, to flatten the five-layer strip, such that the difference in the length is accumulated at an end of the five-layer strip, so as to reduce the influence of the difference in the length on the manufacturing process. However, since the thickness of the five-layer strip is unevenly distributed, layers may be further unaligned by the roll system.

As can be seen, when a three-dimensional wound iron core is manufactured by using the multi-layer amorphous strip, it is difficult to control the accuracy, and probabilities of unaligned layers and uneven tension is increased, resulting in great deviations in the angle and the diameter of the wound amorphous three-dimensional wound iron core. In this case, the coil needs to be designed with a great margin, the production cost is high, and it is difficult to improve manufacturing efficiency and quality consistency.

### SUMMARY

An object of the present disclosure is to provide a method for manufacturing a three-dimensional wound iron core by using a single-layer amorphous strip, to solve the problem of unaligned layers of a multi-layer strip during processes of cutting and winding due to unequal lengths of different layers of the multi-layer strip, such that manufacturing efficiency during a process of manufacturing an iron core and the quality of products can be improved. Another object of the present disclosure is to provide a device for manufacturing a three-dimensional wound iron core by using a single-layer amorphous strip. Another object of the present disclosure is to provide a three-dimensional wound iron core.

In order to solve the above technical problems, the following technical solutions are provided according to the present disclosure.

A method for manufacturing a three-dimensional wound iron core by using a single-layer amorphous strip is provided. The method includes the following steps 1) to 6).

In step 1) of cutting, the single-layer amorphous strip is cut by using a cutting apparatus to obtain a raw material.

In step 2) of positioning, the raw material is positioned at a positioning location by using a first location detecting apparatus, information from the first location detecting apparatus is collected by using a control apparatus in a real time manner, and the information is transmitted to the cutting apparatus by using the control apparatus, to adjust a location of the raw material.

In step 3) of tension detecting, a tension of the positioned raw material is detected by using a tension detecting apparatus, information from the tension detecting apparatus is collected by using the control apparatus in a real time manner, and the information is transmitted to a subsequent winding apparatus by using the control apparatus, to adjust the tension.

In step 4) of trimming, the raw material of which the tension is detected is trimmed by using a trimming apparatus, to obtain a winding strip and a remaining strip.

In step 5) of winding location detecting, the winding strip is positioned at a positioning location by using a second location detecting apparatus, information from the second location detecting apparatus is collected by using the control apparatus in a real time manner, and the information is transmitted to the subsequent winding apparatus by using the control apparatus, to adjust a location of the winding strip.

In step 6) of winding, the winding strip is wound by using the winding apparatus.

Preferably, the step 6) may further include material collecting, which includes collecting the remaining strip by using a material collecting apparatus.

Preferably, the step 5) may further include material collecting location detecting, which includes: positioning, by using a third location detecting apparatus, the remaining strip at a positioning location, collecting, by using the control apparatus, information from the third location detecting apparatus in a real time manner, and transmitting, by using the control apparatus, the information to the material collecting apparatus, to adjust a location of the remaining strip.

Preferably, the third location detecting apparatus may be an apparatus for detecting and correcting deviation.

Preferably, each of the first location detecting apparatus and the second location detecting apparatus may be an apparatus for detecting and correcting deviation.

Preferably, in the step 1) and the step 4), a processing accuracy of a width of the raw material may be ±0.5 mm.

Preferably, in the step 5) of winding location detecting, a layer alignment accuracy is ±0.5 mm.

A three-dimensional wound iron core manufactured by using a single-layer amorphous strip is further provided according to the present disclosure.

A device for manufacturing a three-dimensional wound iron core by using a single-layer amorphous strip is provided according to the present disclosure. The device includes a cutting apparatus, a tension detecting apparatus, a trimming apparatus, and a winding apparatus which are successively connected.

The cutting apparatus is configured to cut the single-layer amorphous strip to obtain a raw material.

The tension detecting apparatus is configured to detect a tension of the raw material.

The trimming apparatus is configured to trim the raw material, to obtain a winding strip and a remaining strip.

The winding apparatus is configured to wind the winding strip.

A first location detecting apparatus is arranged between the cutting apparatus and the trimming apparatus, the first location detecting apparatus being configured to detect a location of the raw material.

A second location detecting apparatus is arranged between the tension detecting apparatus and the winding apparatus, the second location detecting apparatus being configured to detect a location of the winding strip.

The device further includes a control apparatus configured to: collect information from the first location detecting apparatus, to control the cutting apparatus, and collect information from the second location detecting apparatus, to control the winding apparatus.

Preferably, the above device for manufacturing a three-dimensional wound iron core by using a single-layer amorphous strip may further include a material collecting apparatus and a third location detecting apparatus. The control apparatus communicates with the third location detecting apparatus and the material collecting apparatus.

Preferably, each of the first location detecting apparatus, the second location detecting apparatus and the third location detecting apparatus is an apparatus for detecting and correcting deviation.

The method for manufacturing a three-dimensional wound iron core by using a single-layer amorphous strip provided according to the present disclosure includes the following steps 1) to 6). In step 1) of cutting, the single-layer amorphous strip is cut by using a cutting apparatus to obtain a raw material. In step 2) of positioning, the raw material is positioned at a positioning location by using a first location detecting apparatus, information from the first location detecting apparatus is collected by using a control apparatus in a real time manner, and the information is transmitted to the cutting apparatus by using the control apparatus, to adjust a location of the raw material. In step 3) of tension detecting, a tension of the positioned raw material is detected by using a tension detecting apparatus, information from the tension detecting apparatus is collected by using the control apparatus in a real time manner, and the information is transmitted to a subsequent winding apparatus by using the control apparatus, to adjust the tension. In step 4) of trimming, the raw material of which the tension is detected is trimmed by using a trimming apparatus, to obtain a winding strip and a remaining strip. In step 5) of winding location detecting, the winding strip is positioned at a positioning location by using a second location detecting apparatus, information from the second location detecting apparatus is collected by using the control apparatus in a real time manner, and the information is transmitted to the subsequent winding apparatus by using the control apparatus, to adjust a location of the winding strip. In step 6) of winding, the winding strip is wound by using the winding apparatus.

With the method for manufacturing a three-dimensional wound iron core by using a single-layer amorphous strip according to the present disclosure, a problem of unaligned layers of a multi-layer strip during processes of cutting and winding due to unequal lengths of different layers of the multi-layer strip can be solved, and manufacturing efficiency during a process of manufacturing an iron core and the quality of products can be improved. Further, accuracy control can be improved, efficiency of product manufacturing can be improved, the transformer coil can be designed with a small margin, and the cost of the transformer coil can be reduced. Compared with the multi-layer strip, manufacturing cost is reduced since the processes of unrolling, laminating, and rolling are eliminated. During the processes of cutting and winding of the strip, accuracy control and manufacturing efficiency can be improved.

### BRIEF DESCRIPTION OF THE DRAWINGS

FIG. 1 is a schematic structural diagram showing a device for manufacturing a three-dimensional wound iron core by using a single-layer amorphous strip according to an embodiment of the present disclosure.

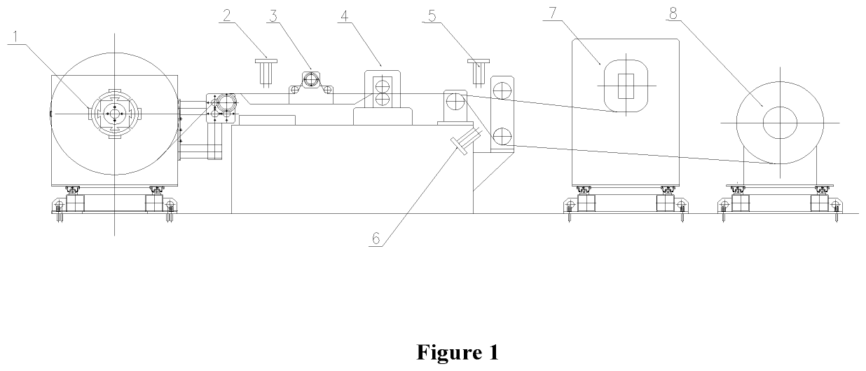

In FIG. 1:

| | |
|---|---|
| 1 cutting apparatus | 2 first location detecting apparatus |
| 3 tension detecting apparatus | 4 trimming apparatus |
| 5 second location detecting | 6 third location detecting apparatus |
| apparatus | |
| 7 winding apparatus | 8 material collecting apparatus |

### DETAILED DESCRIPTION OF THE EMBODIMENTS

In order to enable those skilled in the art to better understand the technical solutions of the present disclosure, the present disclosure is described in detail below through embodiments with reference to the drawings.

Reference is made to FIG. 1, which is a schematic structural diagram showing a device for manufacturing a three-dimensional wound iron core by using a single-layer amorphous strip according to an embodiment of the present disclosure.

The method for manufacturing a three-dimensional wound iron core by using a single-layer amorphous strip provided according to an embodiment of the present disclosure includes the following steps 1) to 6). In step 1) of cutting, the single-layer amorphous strip is cut by using a cutting apparatus 1 to obtain a raw material. In step 2) of positioning, the raw material is positioned at a positioning location by using a first location detecting apparatus 2, information from the first location detecting apparatus 2 is collected by using a control apparatus in a real time manner, and the information is transmitted to the cutting apparatus 1 by using the control apparatus, to adjust a location of the raw material. In step 3) of tension detecting, a tension of the positioned raw material is detected by using a tension detecting apparatus 3, information from the tension detecting apparatus 3 is collected by using the control apparatus in a real time manner, and the information is transmitted to a subsequent winding apparatus 7 by using the control apparatus, to adjust the tension. In step 4) of trimming, the raw material of which the tension is detected is trimmed by using a trimming apparatus 4, to obtain a winding strip and a remaining strip. In step 5) of winding location detecting, the winding strip is positioned at a positioning location by using a second location detecting apparatus 5, information from the second location detecting apparatus 5 is collected by using the control apparatus in a real time manner, and the information is transmitted to the subsequent winding apparatus 7 by using the control apparatus, to adjust a location of the winding strip. In step 6) of winding, the winding strip is wound by using the winding apparatus 7.

A three-dimensional wound iron core is further provided according to the present disclosure. The three-dimensional wound iron core is manufactured by using a single-layer amorphous strip.

With the method for manufacturing a three-dimensional wound iron core by using a single-layer amorphous strip according to the embodiment of the present disclosure, a problem of unaligned layers of a multi-layer strip during processes of cutting and winding due to unequal lengths of different layers of the multi-layer strip can be solved, and manufacturing efficiency during a process of manufacturing an iron core and the quality of products can be improved. Further, accuracy control can be improved, efficiency of product manufacturing can be improved, the transformer coil can be designed with a small margin, and the cost of the transformer coil can be reduced. Compared with the multi-layer strip, manufacturing cost is reduced since the processes of unrolling, laminating, and rolling are eliminated. During the processes of cutting and winding of the strip, accuracy control and manufacturing efficiency can be improved.

In order to further optimize the above technical solution, the step 6) includes a step of material collecting, which includes collecting the remaining strip by using a material collecting apparatus 8, thereby avoiding material waste. Specifically, step 5) further includes material collecting location detecting, where the remaining strip is positioned at a positioning location by using a third location detecting apparatus 6, information from the third location detecting apparatus 6 is collected by using the control apparatus in a real time manner, and the information is transmitted to the material collecting apparatus 8 by using the control apparatus, to adjust a location of the remaining strip, thereby avoiding unaligned layers of the collected material.

Each of the first location detecting apparatus 2, the second location detecting apparatus 5 and the third location detecting apparatus 6 is an apparatus for detecting and correcting deviation, which is an existing apparatus.

In step 1) and step 4), the processing accuracy of a width of the raw material is ±0.5 mm. In step 5) of winding location detecting, the layer alignment accuracy is ±0.5 mm.

A device for manufacturing a three-dimensional wound iron core by using a single-layer amorphous strip is further provided according to an embodiment of the present disclosure. The device includes a cutting apparatus 1, a tension detecting apparatus 3, a trimming apparatus 4, a winding apparatus 7 which are successively connected. The cutting apparatus 1 is configured to cut the single-layer amorphous strip to obtain a raw material. The tension detecting apparatus 3 is configured to detect a tension of the raw material. The trimming apparatus 4 is configured to trim the raw material, to obtain a winding strip and a remaining strip. The winding apparatus 7 is configured to wind the winding strip. A first location detecting apparatus 2 is arranged between the cutting apparatus 1 and the trimming apparatus 4 and is configured to detect a location of the raw material. A second location detecting apparatus 5 is arranged between the tension detecting apparatus 3 and the winding apparatus 7 and is configured to detect a location of the winding strip. The device further includes a control apparatus configured to: collect information from the first location detecting apparatus 2, to control the cutting apparatus 1, and collect information from the second location detecting apparatus 5, to control the winding apparatus 7.

With the device for manufacturing a three-dimensional wound iron core by using a single-layer amorphous strip according to an embodiment of the present disclosure, a problem of unaligned layers of a multi-layer strip during processes of cutting and winding due to unequal lengths of different layers of the multi-layer strip can be solved, such that manufacturing efficiency during a process of manufacturing an iron core and the quality of products can be improved.

The above device for manufacturing a three-dimensional wound iron core by using a single-layer amorphous strip further includes a material collecting apparatus 8 and a third location detecting apparatus 6. The control apparatus communicates with the third location detecting apparatus 6 and the material collecting apparatus 8. The control apparatus collects information from the third location detecting apparatus 6, to control the material collecting apparatus 8.

A diverting apparatus is arranged subsequent to the trimming apparatus 4. The diverting apparatus 4 includes a first fixed pulley, a second fixed pulley, and a third fixed pulley. The winding strip and the remaining strip are conveyed through the first fixed pulley, then the winding strip is conveyed to the winding apparatus 7 through the second fixed pulley, and the remaining strip is conveyed to the material collecting apparatus 8 through the third fixed pulley. In this way, the winding strip and the remaining strip are processed separately, to improve operating efficiency.

Specifically, the second fixed pulley is arranged above the third fixed pulley. A portion of the remaining strip between the first fixed pulley and the third fixed pulley is inclined. The third location detecting apparatus 6 is arranged to be inclined and below the remaining strip. The second fixed pulley and the third fixed pulley are arranged on the same bracket. The structure is simple and is convenient to use.

The material collecting apparatus 8 is arranged behind the winding apparatus 7 and lower than the winding apparatus 7, such that the material collecting apparatus 8 and the winding apparatus 7 do not interfere with each other.

The first location detecting apparatus 2 is arranged above the raw material, and the second location detecting apparatus 5 is arranged above the winding strip, to facilitate the location detection.

In practice, the device for manufacturing a three-dimensional wound iron core by using a single-layer amorphous strip performs the following steps (1) to (8).

In step (1) of cutting, the single-layer amorphous strip is cut (released) to obtain a raw material.

In step (2) of positioning, which is also referred to as cutting deviation detecting and correcting, deviation of the raw material is detected by using an apparatus for detecting and correcting deviation, and the deviation is provided to the cutting apparatus 1 to perform alignment, such that the original locations of the raw materials are consistent, with an allowable deviation being ±0.1 mm.

In step (3) of tension detection, the tension detecting apparatus 3 detects a tension of the positioned raw material, and the detected tension is feed back to the winding apparatus 7, to ensure a constant tension.

In step (4) of trimming, the tensioned raw material is trimmed, according a trimming information table, to obtain a strip having a required size which is referred to as the winding strip, and the remaining strip other than the winding strip.

In step (5) of winding location detecting, which is also referred to as winding deviation detecting and correcting, deviation of the winding strip is detected by using an apparatus for detecting and correcting deviation and is provided to the winding apparatus 7 to perform alignment, such that positioning of the winding strip meets the winding accuracy requirement during winding of the winding strip, where a an allowable deviation is ±0.5 mm.

In step (6) of material collecting deviation detecting and correcting, deviation of the remaining strip is detected by using an apparatus for detecting and correcting deviation and is provided to the material collecting apparatus 8 to perform alignment, such that unaligned layers during material collecting can be avoided, where an allowable deviation is ±1 mm.

In step (7) of winding, the winding strip obtained by trimming is wound by using the winding apparatus 7, to form a three-dimensional wound iron core.

In step (8) of material collecting, another strip, that is, the remaining strip obtained by trimming, is collected by the material collecting apparatus 8.

During the processes of cutting and trimming, a deviation of the width of the strip is controlled to be ±0.5 mm, and is preferably ±0.2 mm. A layer alignment deviation of the obtained three-dimensional wound iron core is ±0.5 mm, and is preferably ±0.4 mm. The layer alignment deviation indicates that end faces of an outer layer and an inner layer of the wound strip are unaligned in the width direction of the wound strip.

Specific examples are used herein to explain the principle and embodiments of the present disclosure, and the above description of the embodiments is only used to facilitate understanding of the method and core concept of the present disclosure. It should be pointed out that for those skilled in the art, various improvements and modifications can be made without departing from the principle of the present disclosure, and these improvements and modifications should fall within the scope of protection of the present disclosure.

1. A method for manufacturing a three-dimensional wound iron core by using a single-layer amorphous strip, comprising:
step 1) of cutting, comprising: cutting, by using a cutting apparatus, the single-layer amorphous strip to obtain a raw material;
step 2) of positioning, comprising: positioning, by using a first location detecting apparatus, the raw material at a positioning location, collecting, by using a control apparatus, information from the first location detecting apparatus in a real time manner, and transmitting, by using the control apparatus, the information to the cutting apparatus, to adjust a location of the raw material;
step 3) of tension detecting, comprising: detecting, by using a tension detecting apparatus, a tension of the positioned raw material, collecting, by using the control apparatus, information from the tension detecting apparatus in a real time manner, and transmitting, by using the control apparatus, the information to a subsequent winding apparatus, to adjust the tension;
step 4) of trimming, comprising: trimming, by using a trimming apparatus, the raw material of which the tension is detected, to obtain a winding strip and a remaining strip;
step 5) of winding location detecting, comprising: positioning, by using a second location detecting apparatus, the winding strip at a positioning location, collecting, by using the control apparatus, information from the second location detecting apparatus in a real time manner, and transmitting, by using the control apparatus, the information to the subsequent winding apparatus, to adjust a location of the winding strip; and
step 6) of winding, comprising: winding the winding strip by using the winding apparatus.

2. The method for manufacturing a three-dimensional wound core by using a single-layer amorphous strip according to claim 1, wherein the step 6) further comprises material collecting, which comprises: collecting the remaining strip by using a material collecting apparatus.

3. The method for manufacturing a three-dimensional wound iron core by using a single-layer amorphous strip according to claim 2, wherein the step 5) further comprises material collecting location detecting, which comprises: positioning, by using a third location detecting apparatus, the remaining strip at a positioning location, collecting, by using the control apparatus, information from the third location detecting apparatus in a real time manner, and transmitting, by using the control apparatus, the information to the material collecting apparatus, to adjust a location of the remaining strip.

4. The method for manufacturing a three-dimensional wound iron core by using a single-layer amorphous strip according to claim 3, wherein each of the first location detecting apparatus, the second location detecting apparatus and the third location detecting apparatus is an apparatus for detecting and correcting deviation.

5. The method for manufacturing a three-dimensional wound iron core by using a single-layer amorphous strip according to claim 1, wherein
in the step 1) and the step 4), a processing accuracy of a width of the raw material is ±0.5 mm.

6. The method for manufacturing a three-dimensional wound iron core by using a single-layer amorphous strip according to claim 1, wherein in the step 5) of winding location detecting, a layer alignment accuracy is ±0.5 mm.

7. A three-dimensional wound iron core manufactured by using a single-layer amorphous strip.

8. A device for manufacturing a three-dimensional wound iron core by using a single-layer amorphous strip, comprising:
a cutting apparatus configured to cut the single-layer amorphous strip to obtain a raw material;
a tension detecting apparatus configured to detect a tension of the raw material;
a trimming apparatus configured to trim the raw material, to obtain a winding strip and a remaining strip;
a winding apparatus configured to wind the winding strip, wherein the cutting apparatus, the tension detecting apparatus, the trimming apparatus and the winding apparatus are successively connected,
a first location detecting apparatus is arranged between the cutting apparatus and the trimming apparatus, the first location detecting apparatus being configured to detect a location of the raw material,
a second location detecting apparatus is arranged between the tension detecting apparatus and the winding apparatus, the second location detecting apparatus being configured to detect a location of the winding strip, and
the device further comprises a control apparatus configured to: collect information from the first location detecting apparatus, to control the cutting apparatus, and collect information from the second location detecting apparatus, to control the winding apparatus.

9. The device for manufacturing a three-dimensional wound iron core by using a single-layer amorphous strip according to claim 8, further comprising:
a material collecting apparatus; and
a third location detecting apparatus, wherein
the control apparatus communicates with the third location detecting apparatus and the material collecting apparatus.

10. The device for manufacturing a three-dimensional wound iron core by using a single-layer amorphous strip according to claim 9, wherein each of the first location detecting apparatus, the second location detecting apparatus and the third location detecting apparatus is an apparatus for detecting and correcting deviation.
